(19) United States
(12) Patent Application Publication
(10) Pub. No.: US 2010/0290088 A1
(43) Pub. Date: Nov. 18, 2010

(54) IMAGE FORMING APPARATUS, AND METHOD PERFORMED BY IMAGE FORMING APPARATUS

(75) Inventor: Akio Ito, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/763,175

(22) Filed: Apr. 19, 2010

(30) Foreign Application Priority Data
May 13, 2009 (JP) 2009-117043

(51) Int. Cl. G06K 15/00

(52) U.S. Cl. 358/1.16

(57) ABSTRACT

This invention allows a user to know whether printed materials to be discharged by executing a print job can be discharged, without waiting for the turn to execute the print job. Upon accepting a print job, an image forming apparatus registers the accepted print job in a print queue and discharges, to one of the lockable discharge units, sheets on which images are formed by executing the registered print job. Upon accepting the print job, the image forming apparatus determines, based on the discharge status of the discharge units after executing a preceding print job registered in the print job, whether sheets to be discharged by executing the print job can be discharged. If the sheets cannot be discharged, the image forming apparatus notifies the user of a message to this effect.

### BACKGROUND OF THE INVENTION

1. Field of the Invention

The present invention relates to an image forming apparatus and a method performed by the image forming apparatus.

2. Description of the Related Art

Some conventional image forming apparatus are equipped with a plurality of discharge units including lockable ones (Japanese Patent Laid-Open No. 11-301066). An image forming apparatus of this type can prevent unspecified users from seeing a printed sheet (printed material) by limiting a user who can simultaneously use one discharge unit. For example, the image forming apparatus manages the use status of the discharge unit (status of discharged printed materials) in correspondence with user information. While a material printed by user A is discharged to a given discharge unit, the image forming apparatus permits discharging a material printed by user A to the given discharge unit, but inhibits discharging a material printed by user B to the given discharge unit and discharges it to another discharge unit. The image forming apparatus can therefore prevent user B from seeing a material printed by user A that is discharged to the given discharge unit.

An image forming apparatus of this type limits a user who can simultaneously use one discharge unit. When a plurality of users uses the image forming apparatus, they may not be able to use it owing to the user limitation. For example, even if an available discharge unit not used by other users exists upon accepting a print job from a given user, the discharge unit may become busy executing another print job while executing the accepted print job. In this case, the user cannot know whether a print job can be executed, till the turn to actually execute it after inputting the print job to the image forming apparatus.

### SUMMARY OF THE INVENTION

The present invention has been made to overcome the conventional drawbacks. It is an object of the present invention to provide a mechanism which allows the user of an image forming apparatus having an exclusive discharge unit to know whether he can use the exclusive discharge unit to execute a print job, without waiting for the turn to execute the print job using the exclusive discharge unit.

The present invention comprises the following arrangement.

According to the first aspect of the invention, an image forming apparatus which discharges a sheet bearing an image to one of a plurality of lockable discharge units, the apparatus comprises:
an accepting unit, configured to accept a print job;
a control unit, configured to control to register a print job accepted by the accepting unit in a print queue, and discharge, to one of the plurality of discharge units, a sheet on which an image is formed by executing the registered print job;
a determination unit, configured to, when the accepting unit accepts the print job, determine, based on discharge statuses of the plurality of discharge units after executing a preceding print job registered in the print queue, whether a sheet to be discharged by executing the print job can be discharged; and
a notification unit, configured to, when the determination unit determines that the sheet cannot be discharged, notify a user that the sheet cannot be discharged.

According to the second aspect of the invention, a method performed by an image forming apparatus which discharges a sheet bearing an image to one of a plurality of lockable discharge units, the method comprises the steps of:
accepting a print job;
controlling to register a print job accepted in the accepting step in a print queue, and discharge, to one of the plurality of discharge units, a sheet on which an image is formed by executing the registered print job;
when the print job is accepted in the accepting step, determining, based on discharge statuses of the plurality of discharge units after executing a preceding print job registered in the print queue, whether a sheet to be discharged by executing the print job can be discharged; and
when the sheet is determined in the determination step not to be able to be discharged, notifying a user that the sheet cannot be discharged.

According to the third aspect of the invention, an image forming apparatus which discharges a sheet bearing an image to one of a plurality of lockable discharge units, the apparatus comprising:
an accepting unit, configured to accept a new print job;
a memory which stores a management table that records use states of the respective lockable discharge units;
a scheduling unit, configured to look up the management table, when all the lockable discharge units are used or reserved by print jobs different in owner from the new print job, notify a user that a free discharge unit which is neither used nor reserved does not exist, and when the free discharge unit exists, input the new print job to the print queue and recording, in the management table, a reservation by the print job as a use state of the free discharge unit; and
an execution unit, configured to extract print jobs sequentially from the print queue, and execute the extracted print jobs using discharge units, reservations of which by the print jobs are recorded in the management table.

According to the present invention, the user can know whether printed materials to be discharged by executing a print job can be discharged, without waiting for the turn to execute the print job.

Further features of the present invention will become apparent from the following description of exemplary embodiments with reference to the attached drawings.

### BRIEF DESCRIPTION OF THE DRAWINGS

FIG. 1 is a block diagram showing a digital multi-function peripheral and network configuration;

FIG. 2 is a view showing the outer appearance of a digital multi-function peripheral 100;

FIG. 3 is a view showing the internal arrangement of the digital multi-function peripheral 100;

FIG. 4 is a block diagram showing a controller block;

FIG. 5 is a table showing a discharge tray management table;

FIGS. 6A and 6B are flowcharts showing job execution determination;

FIG. 7 is a view showing a print designation window;

FIGS. 8A and 8B are tables showing a queue (job list);

FIGS. 9A and 9B are tables showing the sequences of a discharge tray management table and queue;

FIG. 10 is a table showing a management table;

FIGS. 11A and 11B are tables for explaining job execution determination; and

FIG. 12 is a view for explaining a user notification window.

### DESCRIPTION OF THE EMBODIMENTS

A preferred embodiment of the present invention will now be exemplified in detail with reference to the accompanying drawings. However, constituent elements described in the following embodiment are merely examples, and the scope of the invention is not limited to them.

### System Configuration

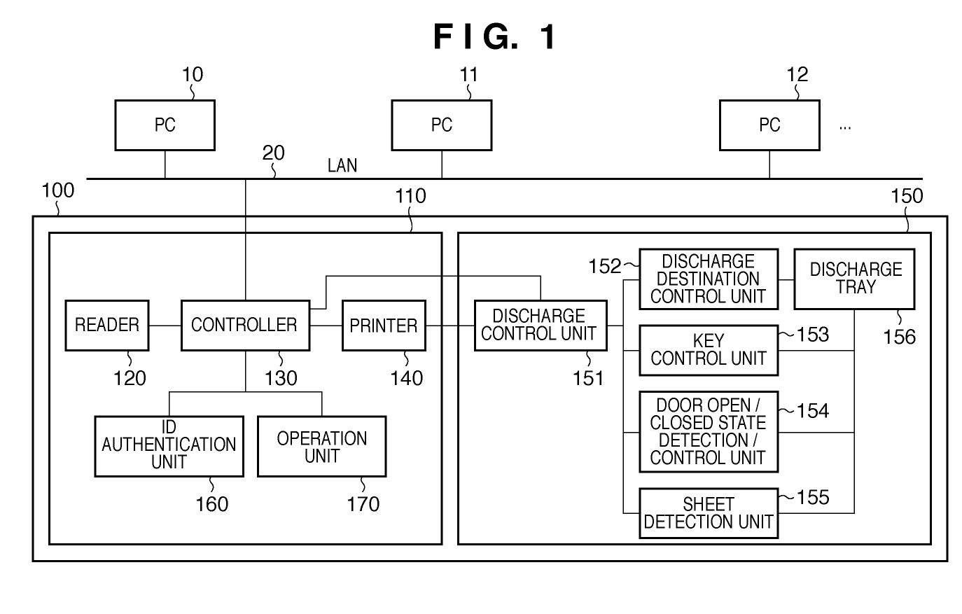

FIG. 1 is a block diagram showing a system configuration in which a digital multi-function peripheral 100 as an embodiment of an image forming apparatus according to the present invention is connected to PCs (Personal Computers) 10 to 12 via a network, and the internal arrangement of the digital multi-function peripheral. In FIG. 1, the digital multi-function peripheral 100 is connected to the PCs 10, 11, and 12 via a network 20. Users A, B, and C use the PCs 10, 11, and 12, respectively. FIG. 1 shows three PCs, but the number of PCs is not limited to three.

The PCs 10, 11, and 12 can transmit/receive data to/from the digital multi-function peripheral 100 via the network 20, and thus can print data and confirm the state of the digital multi-function peripheral 100.

The digital multi-function peripheral 100 includes a multi-function peripheral main body 110 and discharge unit 150. The multi-function peripheral main body 110 includes an image reader 120 which reads a document image, a controller 130 which controls the overall apparatus, a printer 140 which prints on a sheet, an ID authentication unit 160 which authenticates a user, and an operation unit 170 which accepts a manipulation of the digital multi-function peripheral.

The discharge unit 150 includes a discharge control unit 151. The discharge control unit 151 communicates with the controller 130 and printer 140 to control the whole discharge unit 150 based on instructions from them. A discharge destination control unit 152 controls discharge in accordance with selection of the discharge destination. Each key control unit 153 controls the key of a keyed discharge tray. Also, the key control unit 153 can detect a locked state (whether the discharge tray is locked). Each door open/closed state detection/control unit 154 detects the opening/closing operation of the door of a keyed discharge tray. Also, the door open/closed state detection/control unit 154 can control the opening/closing operation of the door. Each sheet detection unit 155 detects the presence/absence of a print result (in other words, printed sheet) in the discharge unit, and the amount of print results. Discharge trays 156 store sheets bearing images, and include a plurality of lockable keyed discharge trays and an unkeyed tray having neither a door nor key. The discharge trays 156 hold discharged print results. The key control unit 153, door open/closed state detection/control unit 154, and sheet detection unit 155 control the discharge trays 156.

FIG. 2 is a view showing the outer appearance of the digital multi-function peripheral 100. The multi-function peripheral main body 110 is illustrated on the right side of FIG. 2, and the discharge unit 150 is illustrated on the left side. The discharge unit 150 includes the discharge trays 156, in other words, 156-0 to 156-5. The discharge tray 156-0 is an unkeyed tray, and discharged sheets are sequentially stacked on it. The discharge trays 156-1 to 156-5 have doors and keys, respectively, and inhibit a user having no key from seeing the inside of the door.

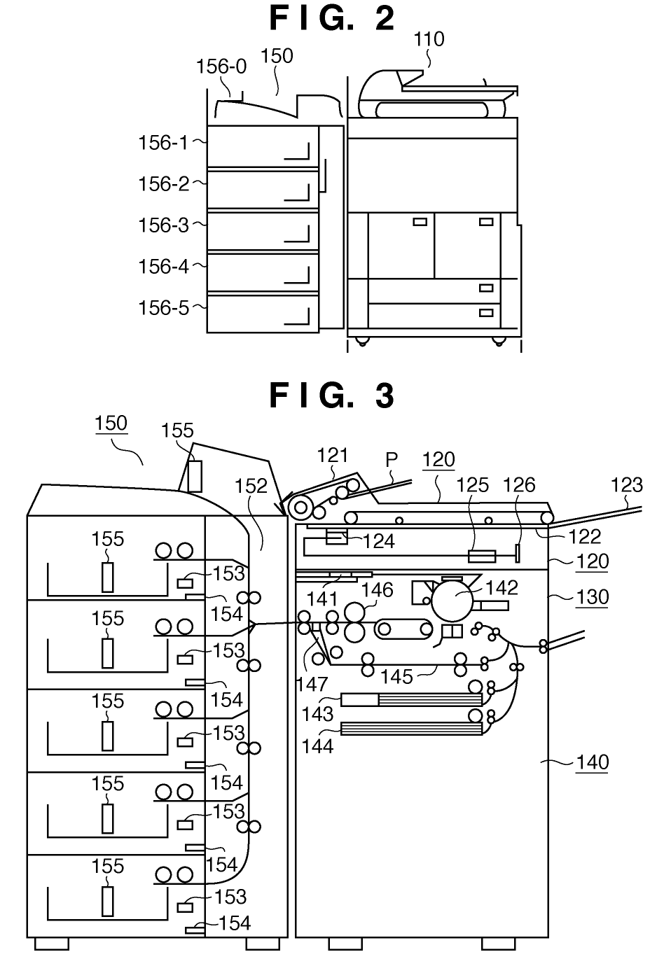

FIG. 3 is a schematic view showing the internal arrangement of the digital multi-function peripheral 100. As shown in FIG. 3, the digital multi-function peripheral 100 includes the image reader 120 which reads a document image, the printer 140, and the discharge unit 150.

A document feeder 121 is mounted on the image reader 120. The document feeder 121 feeds document sheets P, which are set on a document tray to face up, one by one sequentially from the first page to the left. The document sheet is conveyed from left to right on a platen glass 122 along a curved path via a sheetfed scan position, and discharged toward an external discharge tray 123. When the document sheet passes the sheetfed scan position on the platen glass 122 from left to right, the document image is scanned by a scanner unit 124 held at a position corresponding to the sheetfed scan position.

When the document sheet passes the sheetfed scan position, a document surface to be read is irradiated with light from the lamp of the scanner unit 124. The light reflected by the document sheet is guided to a lens 125 via a mirror. The light having passed through the lens 125 forms an image on the image sensing surface of an image sensor 126.

In this way, the document sheet is scanned and read by conveying it to pass the sheetfed scan position from left to right. The image sensor 126 reads the entire document image, converts the optically read image into image data, and outputs the image data.

The image data output from the image sensor 126 undergoes predetermined processing by the controller 130, and then is input as a video signal to an exposure control unit 141 of the printer 140. It is also possible to convey a document sheet on the platen glass 122 by the document feeder 121, stop it at a predetermined position, and read it in this state by scanning the scanner unit 124 from left to right.

The exposure control unit 141 of the printer 140 modulates a laser beam based on the input video signal, and outputs it. The laser beam irradiates a photosensitive drum 142 while being scanned by a polygon mirror or the like. An electrostatic latent image corresponding to the scanned laser beam is formed on the photosensitive drum 142.

The electrostatic latent image on the photosensitive drum 142 is visualized as a developer image with a developer supplied from a developing unit. At a timing synchronized with the start of laser beam irradiation, a sheet is supplied from one of cassettes 143 and 144, a manual feed unit, and a double-sided conveyance path 145. The sheet is conveyed to the photosensitive drum 142. The developer image formed on the photosensitive drum 142 is transferred onto the sheet.

The sheet bearing the developer image is conveyed to a fixing unit 146, which fixes the developer image onto the sheet by thermally pressing the sheet. The sheet having passed through the fixing unit 146 is discharged from the printer 140 to the discharge unit 150.

When the sheet is discharged with its image forming surface facing down (facedown), the sheet having passed through the fixing unit 146 is guided to a reverse path 147 by switching a flapper. After the trailing end of the sheet passes through the flapper, the sheet is switched back and discharged from the printer 140 by discharge rollers. This discharge form will be called reversal discharge. The reversal discharge is performed when forming images sequentially from the first page, for example, when forming images read using the document feeder 121 or forming images output from a computer. The discharged sheets are aligned in a correct page order.

When double-sided printing is set to form images on the two surfaces of a sheet, a sheet is guided to the reverse path 147 by switching the flapper, and then conveyed to the double-sided conveyance path 145. It is controlled to refeed, to the photosensitive drum 142 at the above-described timing, the sheet guided to the double-sided conveyance path 145.

A sheet discharged from the printer 140 is sent to the discharge unit 150. The discharge unit 150 discharges the sheet to a discharge destination (discharge tray). The discharge unit includes the six discharge trays 156-0 to 156-5. The unkeyed discharge tray 156-0 cannot be locked. The discharge trays 156-1 to 156-5 have doors, respectively, and can be locked.

A conveyance path is selected under flapper control by the discharge destination control unit 152. The sheet sent from the printer 140 to the discharge unit 150 is discharged to a desired discharge destination among the six discharge trays.

Sheets sent to the discharge unit 150 are sequentially stacked so that a previously sent sheet lies below. On condition that authentication by the ID authentication unit 160 is successful, the key control unit 153 permits unlocking the keys of the doors of the discharge trays 156-1 to 156-5 and opening the doors. The sheet detection unit 155 is arranged in each of the discharge trays 156-1 to 156-5 to detect the remaining amount of discharged sheets. The door open/closed state detection/control unit 154 can control and detect the opening/closing operation of the door.

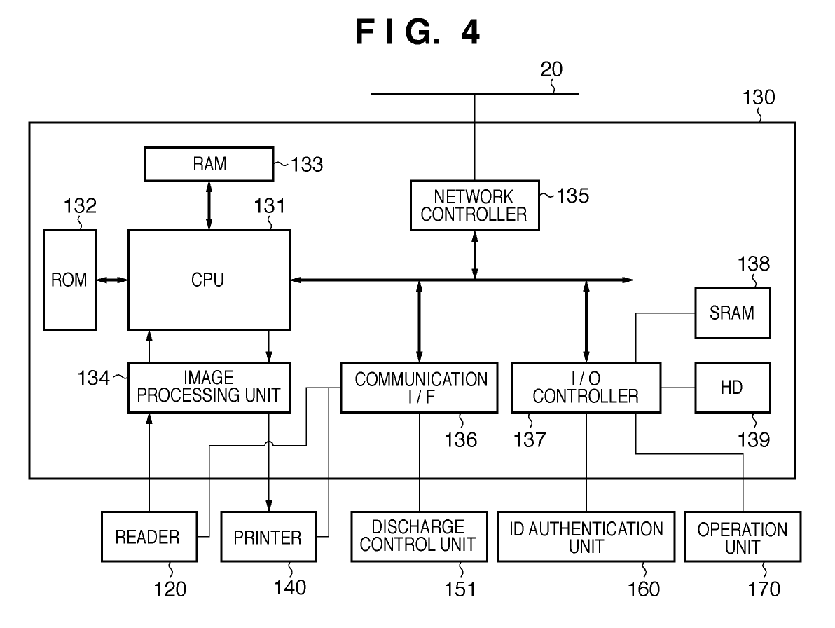

FIG. 4 is a block diagram showing the arrangement of the controller 130. A CPU 131 is a controller IC which controls the overall digital multi-function peripheral 100 and incorporates a CPU core and image processing block. A RAM 133 is a system work memory used when the CPU 131 runs, and is also an image memory for temporarily storing image data. A ROM 132 is a boot ROM which stores a boot program for activating the system.

The CPU 131 is connected to a network controller 135, communication I/F 136, and I/O controller 137 via a system bus capable of quickly transmitting/receiving communication data, image data, and the like.

The network controller 135 is a controller which is connected to the network 20 and transmits/receives data. The network controller 135 can flexibly communicate with a PC and external device connected to the network 20, and input/output image data, device information, and the like.

The I/O controller 137 controls a variety of I/O devices. The CPU 131 can control an HD 139, the

ID authentication unit 160, and the operation unit 170 via the I/O controller 137.

The HD 139 is a hard disk drive which stores system software, image data, system management data, box management data, and the like. An SRAM 138 is a memory which is backed up by a battery and can hold various setting data of the controller 130.

The ID authentication unit 160 authenticates a user, and can read information accumulated in a device such as an IC card. The read data is compared with user information accumulated in the HD 139 and user information of a job during execution. In accordance with the comparison result, the right to use the digital multi-function peripheral 100 is given, various settings are made, and processing corresponding to an execution job is done.

The operation unit 170 is used to make a variety of settings of the digital multi-function peripheral. The I/O controller 137 and operation unit 170 exchange communication data and display data. The communication data is used to detect a key input via the operation unit 170. The display data is used for display on the display of the operation unit 170.

An image processing unit 134 is a block which performs various image processes such as image reduction, enlargement, and luminance-to-density conversion. The image processing unit 134 is formed from an image processing part for image data input from the image reader 120, and an image processing part for image data to be output to the printer 140.

Image data read by the image reader 120 is input to the CPU 131 via the image processing unit 134, and temporarily stored in the RAM 133. The CPU 131 incorporates blocks for compressing, decompressing, and rotating an image. The CPU 131 can access image data stored in the RAM 133 to execute various kinds of processes.

Compressed image data is transferred to the HD 139 via the I/O controller 137 and stored in it. An image stored in the HD 139 can be read out by the CPU 131, decompressed, and formed on a sheet by the printer 140.

Image data can be transmitted to an external device connected to the network 20 via the network controller 135.

The image reader 120 and printer 140 exchange image data via the image processing unit 134, and communicate via the communication I/F 136. The communication I/F 136 also communicates with the discharge control unit 151 and instructs it to control the discharge unit.

Print data received from a PC (computer) or the like via the network 20 is input to the RAM 133 via the network controller 135 and CPU 131. A raster image processor (RIP) block in the CPU 131 rasterizes the PDL code of the received print data into a bitmap image. The rasterized image data is transferred to the printer 140. The printer 140 forms an image on a sheet in accordance with the received image data. Data received via the network controller 135 can be printed, and in addition, stored in the HD 139 or transmitted to an external device.

The printer 140 includes a plurality of sheet feed sources and sheet cassettes corresponding to them so that different sheet sizes or sheet orientations can be selected. A sheet bearing an image formed by the printer 140 is sent to the discharge unit 150 and discharged onto a keyed discharge tray or unkeyed tray.

### Discharge Unit Management Method

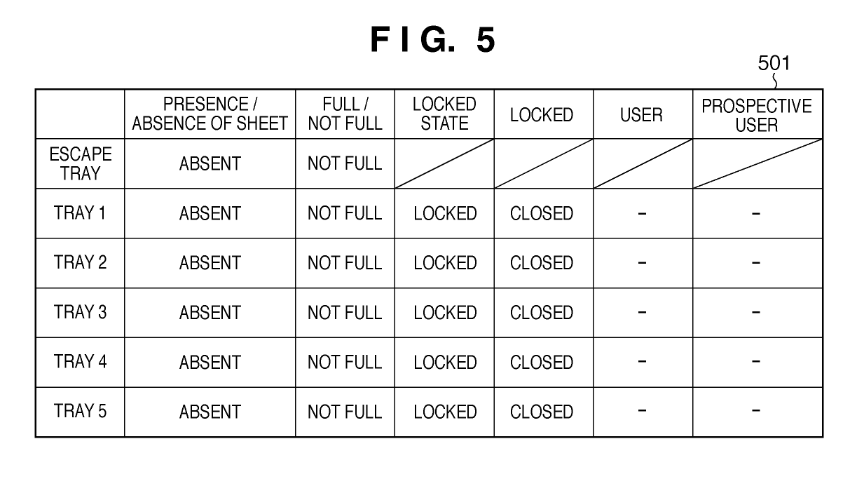

A method of managing the discharge unit 150 will be explained. FIG. 5 is a table showing a management table for managing the discharge unit. The management table represents the state (discharge status) of each discharge tray of the discharge unit 150. The management table manages the presence/absence of a sheet on the discharge tray, whether the discharge tray is full, the locked state of a keyed discharge tray, and the open/closed state of the door of a keyed discharge tray. Further, the management table in FIG. 5 manages a print job and user which now use each keyed discharge tray, and a print job and user which are to use a keyed discharge tray. The management table is generally stored in the SRAM 138 which can be quickly accessed. The management table is looked up by the CPU 131 and backed up in the HD 139 at a predetermined timing. More specifically, the CPU 131 and SRAM 138 function as a discharge unit management means for managing a user and prospective user based on the management table for each of the discharge units. The user of a given discharge unit means a print job which is being processed or has been processed and has sheets discharged on the discharge unit, and the owner of the print job. The prospective user of a discharge unit means a print job for which sheets are to be discharged to the discharge unit by executing the print job in the print queue, and the owner of the print job. A print job to discharge sheets to a discharge unit, and information of the owner of the print job are stored in the management table in association with each discharge unit. The management table can therefore manage a discharge unit and a user who discharges sheets to it.

In the embodiment, the identifier of a print job and that of the user of the print job are used as each of a user and prospective user. This is because in this embodiment, a discharge tray used or reserved for a print job by a given user can be reserved for another print job by the same user. If the reservation for such a print job is inhibited, the management table suffices to manage only the user names of a user and prospective user.

The “presence/absence of a sheet” and “full/not full” managed in the management table reflect a detection result by the sheet detection unit 155. In the “open/closed state of a key”, a value reflecting a detection result by the key control unit 153 is written. In the “door state”, a value reflecting a detection result by the door open/closed state detection/control unit 154 is written.

The controller 130 receives detection results by the key control unit 153, sheet detection unit 155, and door open/closed state detection/control unit 154 via the discharge control unit 151. The discharge control unit 151 and controller 130 communicate data at predetermined intervals. When the state changes, data is updated. The detection result data input from the discharge unit 150 to the controller 130 are input to the RAM 133 via the communication I/F 136 and CPU 131, updating the management table. The management table in the HD 139 is overwritten with that in the RAM 133.

### Job Acceptance Processing

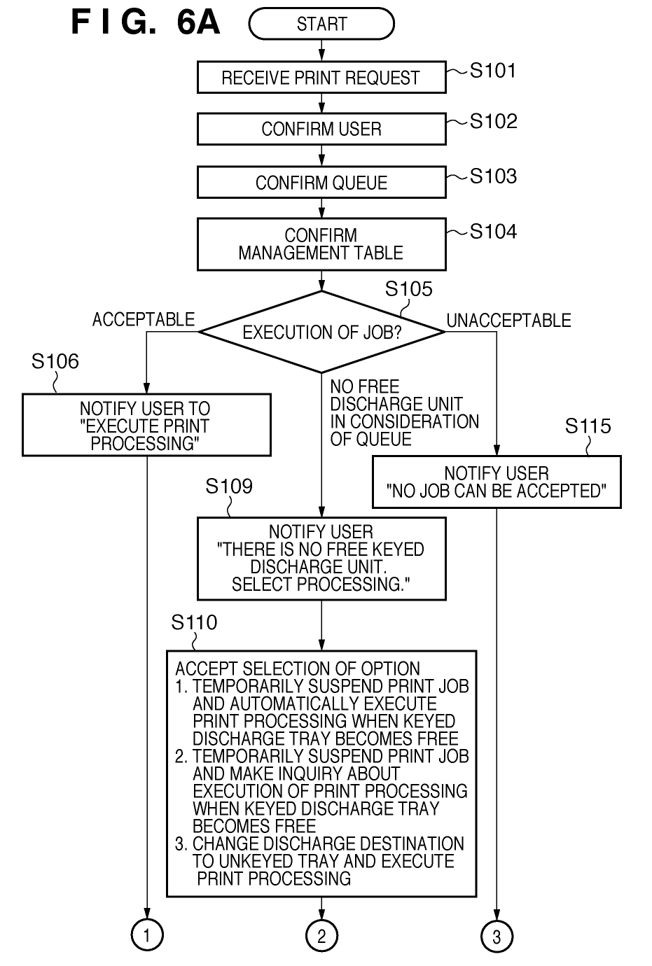

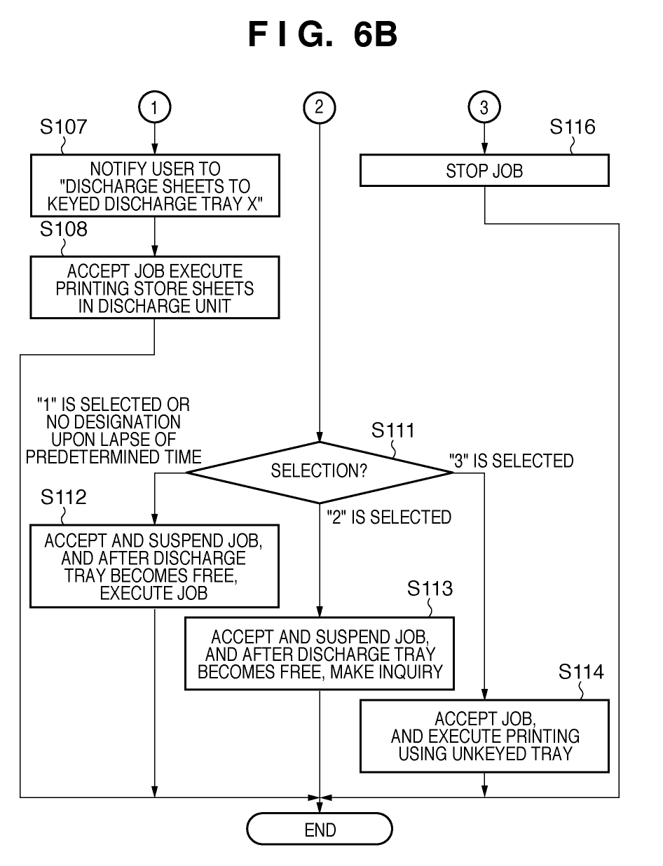

Job acceptance processing executed in the digital multi-function peripheral 100 will be explained with reference to the flowchart of FIGS. 6A and 6B. FIGS. 6A and 6B is a flowchart showing the sequence of processing until the digital multi-function peripheral 100 executes printing upon receiving a print request. The processing in FIGS. 6A and 6B can be implemented as, for example, part of a print job scheduler (not shown).

In step S101, the digital multi-function peripheral 100 receives a print request from one of the PCs 10 to 12. The print request contains information on the user name, file name, print range (all pages, current page, or designated pages), page count, print settings, discharge destination (unkeyed or keyed tray), and copy count. However, the print request does not contain actual image data. The digital multi-function peripheral 100 receives actual image data later, which will be described in detail.

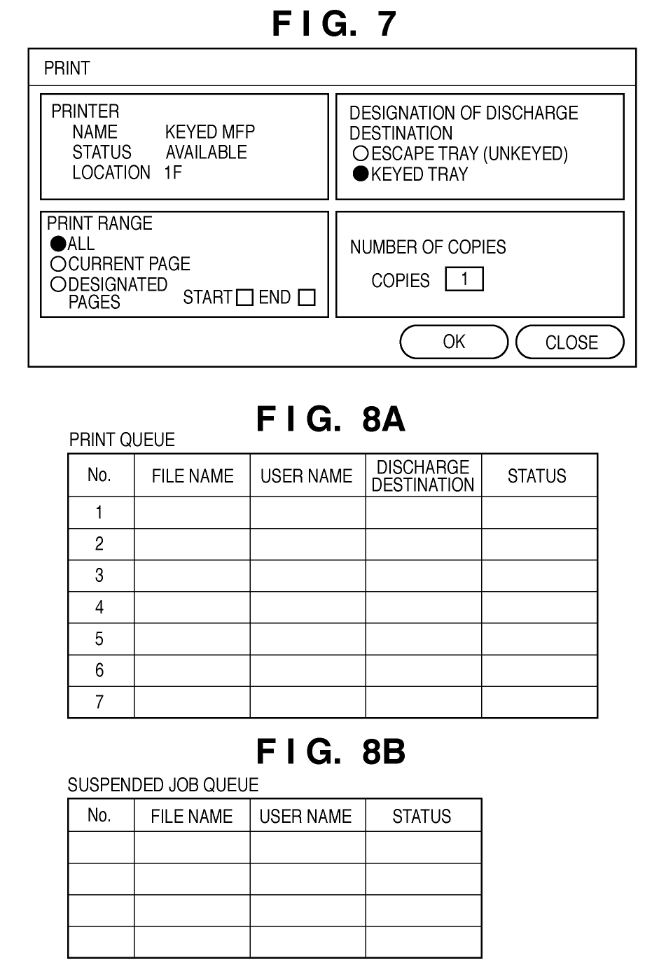

FIG. 7 shows a setup window displayed on the PCs 10 to 12. Upon accepting a print instruction from the user to the digital multi-function peripheral 100, the PCs 10 to 12 display the window in FIG. 7 on their displays. The PCs 10 to 12 accept the settings of an output destination printer, print range, discharge destination, and copy count through the window.

Upon receiving the print request from one of the PCs 10 to 12, the digital multi-function peripheral 100 confirms the user name and print request contents in step 5102. Based on the print request contents, the amount of print results (number of sheets) and whether the discharge destination is a keyed discharge tray can be determined. For example, the amount of print results can be obtained based on the page count, print settings, and copy count received in step S101. For example, when the page count is “10” and the print settings are “4in1” and “double-sided”, the number of sheets to be printed is two. In this case, images of four pages are printed on the obverse of the first sheet, those of four pages are printed on the reverse, and those of the two remaining pages are printed on the reverse of the second sheet. The total number of sheets to be discharged by executing printing corresponding to the print request can be calculated from two sheets x copy count. In this way, the print request in the embodiment is not accompanied with data to be printed. A print job contains both the above-mentioned print settings and target print data. The digital multi-function peripheral 100 schedules and executes print jobs to print.

After that, the process advances to step S103 to confirm a print queue shown in FIG. 8A. The print queue is a job list indicating print jobs during or in wait for processing by the digital multi-function peripheral 100. Similar to the management table, the job list is created in the RAM 133 by the CPU 131 and saved in the HD 139, as needed. That is, the CPU 131 and RAM 133 function as a print job management means for sequentially managing print jobs to be executed in the print queue.

In the print queue, print jobs are numbered in the execution order. The print queue includes an execution file name, user name, discharge destination, and processing status. The digital multi-function peripheral can display the print queue on the operation unit. The status takes three parameters “during determination of the discharge destination”, “waiting for printing”, and “during execution”.

In step S104, the digital multi-function peripheral 100 confirms the state of each discharge tray by looking up the management table shown in FIG. 5. In step S105, the digital multi-function peripheral 100 determines, based on the print request contents confirmed in S102, the print queue confirmed in S103, and the management table confirmed in S104, whether the print job can be executed. At this time, the digital multi-function peripheral 100 determines that the print job can or cannot be executed. The print job cannot be executed in two cases. First, no print job can be executed owing to a trouble or the like. Second, no print job can be executed because all keyed discharge trays are busy and no exclusive discharge can be achieved. A newly scheduled print job cannot utilize a discharge tray to which sheets are discharged by a print job during execution, a discharge tray to which sheets have been discharged by an executed print job and are left, and a discharge tray to which no sheet is discharged at present but sheets are to be discharged by a print job preceding the newly scheduled print job. The two former discharge trays will be called used discharge trays, and the latter one will be called a reserved discharge tray. Discharge trays other than the used and reserved discharge trays are available discharge trays, in other words, free discharge trays.

If the digital multi-function peripheral 100 determines in step S105 that the discharge unit 150 can execute the received print job, the process advances to step S106 to notify the user that “print processing will be executed.” The process then advances to step S107 to notify him of a specified discharge tray. For example, the digital multi-function peripheral 100 transmits a message “sheets will be discharged to keyed discharge tray X” to the PC to display the message. Further, the process advances to step S108 to accept a print job and register it in the print queue.

Printing is executed for print jobs registered in the print queue in the order of them, discharging print results to desired discharge trays.

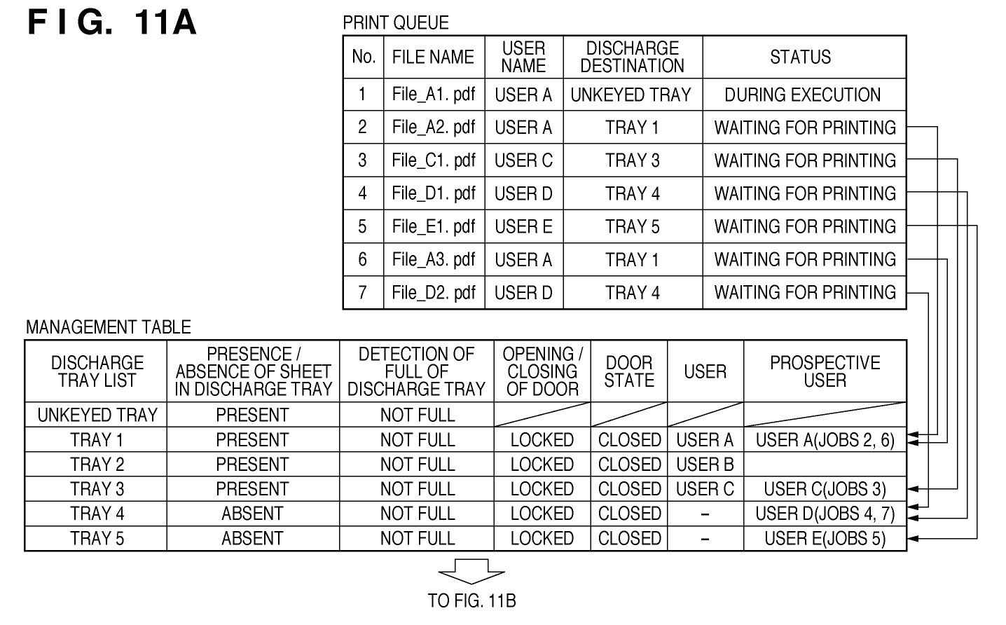

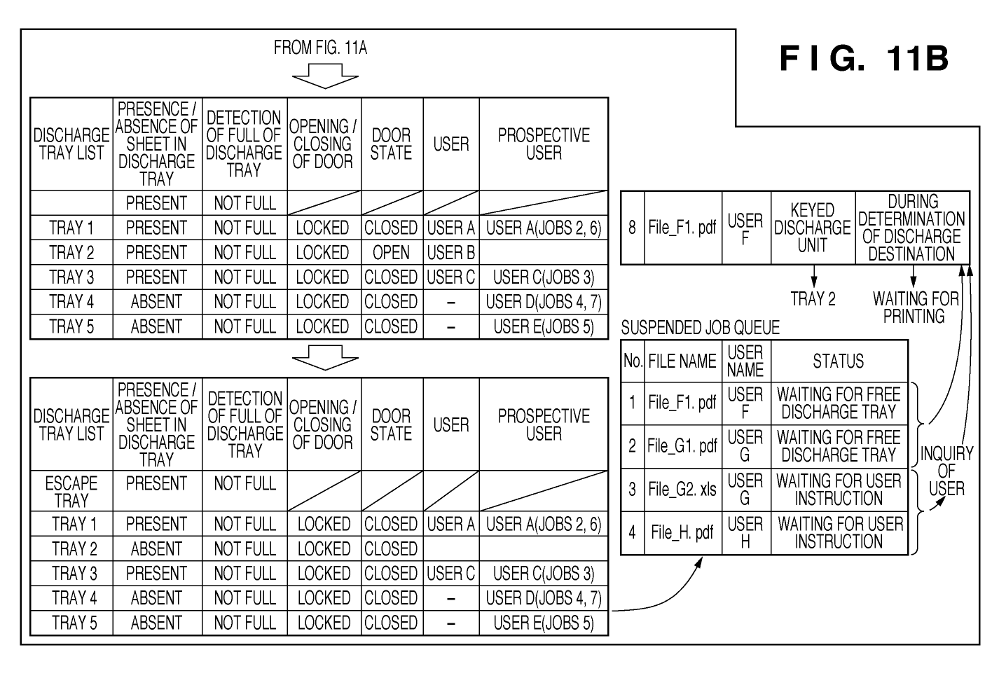

At the start of executing a print job, a status column corresponding to the print job in the print queue is rewritten into “during execution”. When the print job uses a keyed discharge tray, the value in a “prospective user” column corresponding to the discharge tray in the management table is recorded in a “user” column. A prospective user recorded as a user is deleted from the management table. However, when a plurality of print jobs are recorded in the prospective user column, the user name of the prospective user still remains, and only a print job using the discharge tray is deleted from the prospective user column. For example, in FIGS. 11A and 11B, the prospective user of tray 1 is user A in the management table of FIG. 11A. It is also recorded that two print jobs 2 and 6 use tray 1. Thus, even after the start of executing print job 2, the prospective user of tray 1 is still user A. However, print job 2 is deleted from print jobs which are to use tray 1.

For descriptive convenience, step S108 in FIGS. 6A and 6B is described as if acceptance and execution of a print job were synchronized. However, input of a print job to the print queue and extraction of it are executed asynchronously. Hence, a print job is extracted from the print queue and executed in accordance with a software module, for example, a program called a despooler or execution unit, different from a scheduler for inputting a print job to the print queue.

If the digital multi-function peripheral 100 determines in step S105 that no job can be accepted owing to a trouble of the digital multi-function peripheral 100 or the like, the process advances to step S115 to notify the user that “no print job can be accepted.” In step S116, the digital multi-function peripheral 100 stops the acceptance of a job.

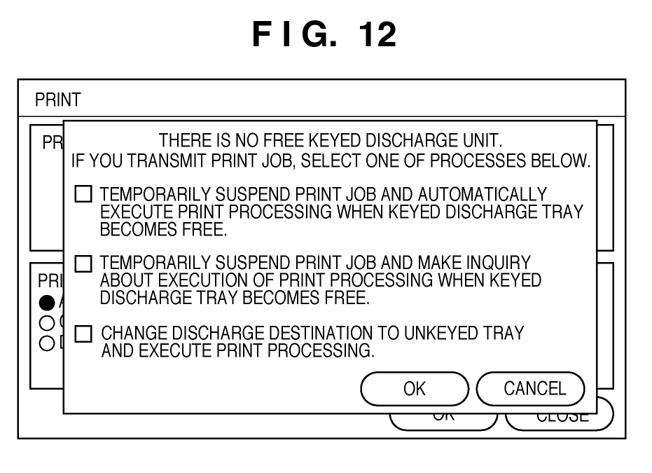

If the digital multi-function peripheral 100 determines in step S105 that the keyed discharge tray is full and the print request received in step S101 cannot be directly executed, the process advances to step S109 to notify the user that the keyed discharge tray is full. In step S110, the digital multi-function peripheral 100 presents three choices (options) on the PC to the user, as shown in FIG. 12, and accepts the selection.

In step S111, the digital multi-function peripheral 100 changes processing to be executed, in accordance with the processing contents selected in step S110. If the user selects “1. automatically execute print processing when the keyed discharge tray becomes free”, or he does not select any choice and a predetermined time has elapsed, the process shifts to step S112. If the user selects “2. make an inquiry about execution of print processing when the keyed discharge tray becomes free”, the process shifts to step S113. If the user selects “3. change the discharge destination to an unkeyed tray and execute print processing”, the process shifts to step S114.

In step S112, the digital multi-function peripheral 100 receives the print job and registers it in a suspended job queue (FIG. 8B) in the HD 139 in accordance with the suspension instruction “1” from the user. Then, the digital multi-function peripheral 100 waits until any keyed discharge tray becomes free. As the status of this print job, a code indicating “waiting for a free discharge tray” is recorded.

When the keyed discharge tray becomes free, the status of the first print job in the suspended job queue is tested. If the status is “waiting for a free discharge tray”, the print job is registered in the print queue and scheduled. In the “discharge destination” column for the print job, the identifier of the free discharge tray is recorded. In addition, the identifier of the newly scheduled print job and the user name of the owner of the print job are recorded in a prospective user column corresponding to the discharge tray in the management table. As a result, the discharge tray is reserved for the print job. The print job is executed in order in the print queue. Procedures to determine whether the keyed discharge tray is free will be described with reference to FIGS. 11A and 11B.

In step S113, the digital multi-function peripheral 100 receives the print job and registers it in the suspended job queue (FIG. 8B) in the HD 139 in accordance with a suspension instruction from the user. The digital multi-function peripheral 100 waits until any keyed discharge tray becomes free. As the status of this print job, a code indicating “waiting for a user instruction” is recorded.

When the keyed discharge tray becomes free, the status of the first print job in the suspended job queue is tested. If the status is “waiting for a user instruction”, a message is output to prompt user authentication and instruction. If the user issues a print instruction again in response to the message, the print job is extracted from the suspended job queue and registered in the print queue. The print job is executed in order in the print queue. If the user issues an instruction other than a print one in response to a message to him, processing is performed in accordance with the instruction. For example, for a processing stop instruction, the print job is extracted from the suspension queue and discarded.

In step S114, the digital multi-function peripheral 100 accepts the print job and changes the discharge setting to an unkeyed tray free from any use limitation. The digital multi-function peripheral 100 executes print processing and discharges sheets to the unkeyed tray.

### Job Management Method

A method of managing a print job received by the digital multi-function peripheral 100 will be described to explain the job execution determination in step S105 of FIG. 6A.

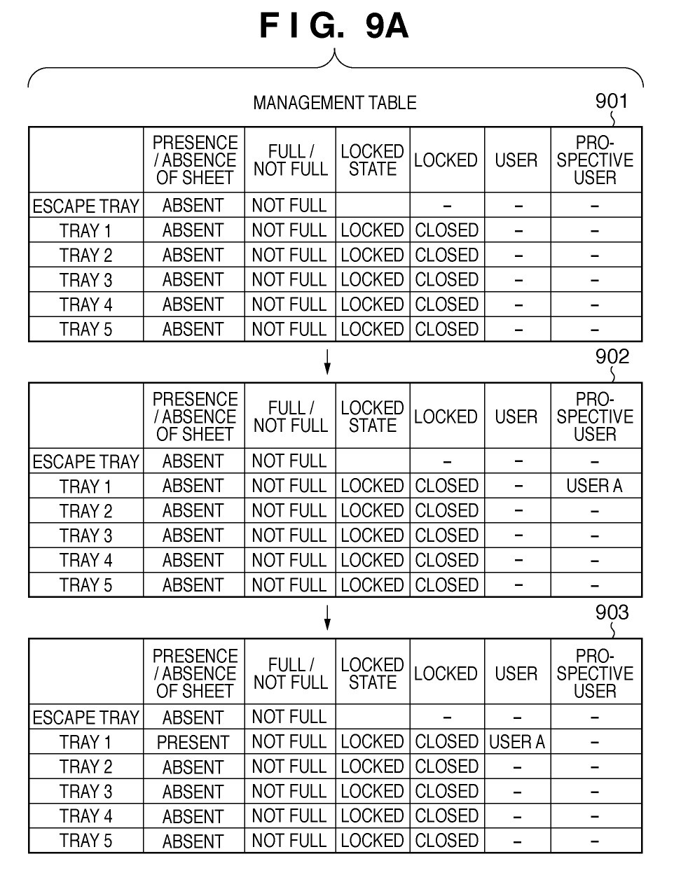

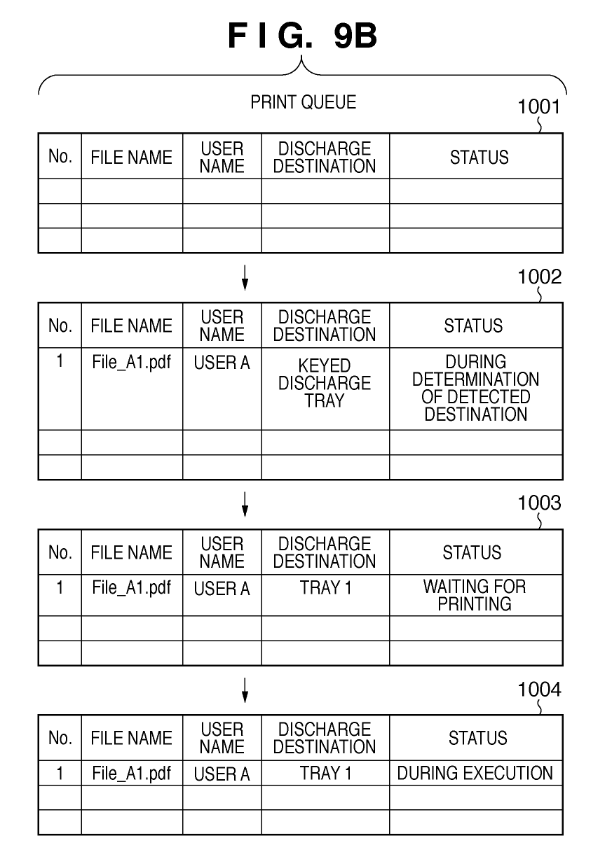

The most basic changes of the management table and print queue will be explained with reference to FIGS. 9A and 9B. When there is neither a job during execution nor a waiting job and no print result (discharged sheet) exists on discharge trays, the management table and print queue are in the states of a management table 901 and print queue 1001. If a print request is accepted in this state, the process in FIG. 6A follows a sequence of S105→S106→S107→S108 to accept a print job and add it to the queue, like a print queue 1002, because there is no problem in executing the job. At this time, the status of the print job is “during determination of the discharge destination”. As keyed discharge trays, all trays 1 to 5 are free, and tray 1 is determined as the discharge destination. Then, the print queue changes to a print queue 1003. At the same time, “user A” is temporarily input to the prospective user column corresponding to tray 1 in the management table, as represented by a management table 902.

After print job 1 actually starts, the status changes to “during execution”, as represented by a print queue 1004. The user column is updated to “user A”, as represented by a management table 903.

After the end of the processing, the print job registered in the print queue is dequeued. When the user opens the door of the discharge tray and takes away discharged sheets, and the discharge tray becomes free from a sheet, the user (user A) of the discharge tray is deleted. Also, the value in the “presence/absence of a sheet” column is changed to “absent”.

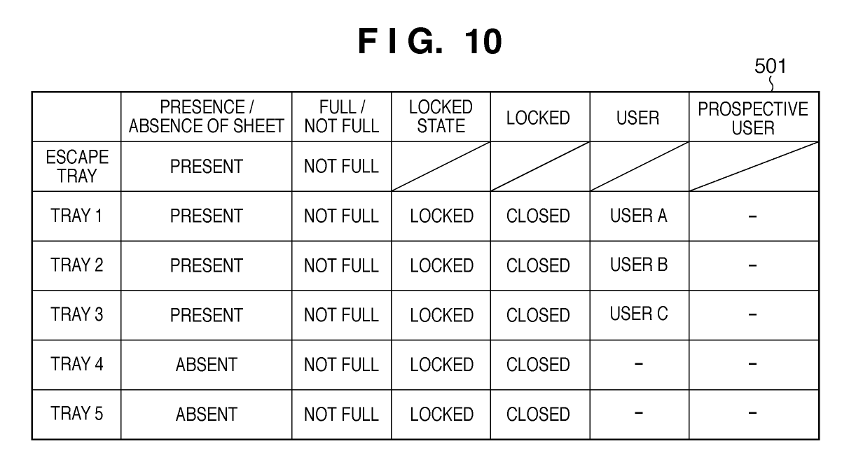

In this manner, upon receiving a print job which uses a keyed discharge tray, the management table changes as shown in FIG. 10. In the example of FIG. 10, user A uses discharge tray 1, user B uses discharge tray 2, and user C uses discharge tray 3.

A case in which a new print job and print request are accepted in the state of FIG. 10 will be explained with reference to FIGS. 11A and 11B. FIGS. 11A and 11B are tables for explaining status changes of the management table, print queue, and suspended job queue.

Print job No. 1 in the print queue of FIGS. 11A and 11B selects discharge to an unkeyed discharge tray by user A. Print jobs are accepted sequentially from the top.

Print job No. 2 selects discharge to a keyed discharge tray by user A. In the state of FIG. 10, user A is registered as the user of keyed discharge tray 1 in the management table. Keyed discharge tray 1 for the same user is set as the discharge destination of print job No. 2, and “waiting for printing” is set as the status.

Print job No. 3 selects discharge to a keyed discharge tray by user C. In the state of FIG. 10, user C is registered as the user of keyed discharge tray 3 in the management table. Keyed discharge tray 3 for the same user is set as the discharge destination of print job No. 3, and “waiting for printing” is set as the status. At the same time, user C is registered in the prospective user column corresponding to keyed discharge tray 3 in the management table.

Print job No. 4 selects discharge to a keyed discharge tray by user D. In the state of FIG. 10, no user is registered as the users and prospective users of keyed discharge trays 4 and 5 in the management table. Thus, keyed discharge tray 4 is set as the discharge destination of print job No. 4, and “waiting for printing” is set as the status. At the same time, user D is registered in the prospective user column corresponding to keyed discharge tray 4 in the management table.

Print job No. 5 selects discharge to a keyed discharge tray by user E. In the state of FIG. 10, no user is registered as the users and prospective users of keyed discharge trays 4 and 5 in the management table. Hence, keyed discharge tray 5 is set as the discharge destination of print job No. 5, and “waiting for printing” is set as the status. Also, user E is registered in the prospective user column corresponding to keyed discharge tray 5 in the management table.

Print job No. 6 selects discharge to a keyed discharge tray by user A. In the management table, user A is registered as the user and prospective user of keyed discharge tray 1. Keyed discharge tray 1 is therefore set as the discharge destination of print job No. 6, and “waiting for printing” is set as the status.

Print job No. 7 selects discharge to a keyed discharge tray by user D. In the management table, user D is registered as the prospective user of keyed discharge tray 4. Keyed discharge tray 4 is set as the discharge destination of print job No. 7, and “waiting for printing” is set as the status.

### Job Execution Determination

How to use user information, the state of the print queue, and the state of the management table to determine whether a job can be executed in step S105 of FIGS. 6A and 6B will be explained in detail with reference to FIGS. 9A to 12.

When the management table and print queue receive a new print job at the timing of the state shown in FIG. 11A, the job execution determination is made as follows in accordance with the print job type.

(1) Upon Receiving Print Job which Selects Discharge to Unkeyed Tray:
There is no user limitation in the use of an unkeyed tray, so it is determined that the print job can be executed. That is, the process in FIG. 6A advances from step S105 to step S106.

(2) Upon Receiving Print Job Whose Owner is User A, B, C, D, or E and which Selects Discharge to Keyed Discharge Tray (in other words, Upon Receiving Print Job whose Owner is the Same User as User of Discharge Destination Tray of Print Job already Registered in Queue and which Selects Discharge to Keyed Discharge Tray):
In this case, all the users have already been registered as prospective users or users in the management table. It is therefore determined that discharge to a keyed discharge tray is possible, and the print job can be accepted. That is, the process in FIG. 6A advances from step S105 to step S106.

(3) Upon Receiving Request from User F to Select Discharge to Keyed Discharge Tray (in other words, Upon Receiving Print Job whose Owner is User Different from Users of Discharge Destination Trays of Print Jobs Registered in Queue and which Selects Discharge to Keyed Discharge Tray):

First, the print queue is checked, and if a preceding job “during determination of the discharge destination” exists, the job execution determination waits until the discharge destination is determined. If the preceding job “during determination of the discharge destination” is dequeued, it is determined whether there is a keyed discharge tray for which neither a user nor prospective user has been registered. If there is a keyed discharge tray for which neither a user nor prospective user has been registered, it is determined that the job can be executed.

In FIGS. 11A and 11B, users other than user F have been registered as prospective users for trays 1, 3, 4, and 5. As for tray 2, no prospective user has been registered, but user B is using tray 2. Thus, there is no keyed discharge tray available for user F. It is determined that the print job cannot be executed, and the process advances from step S105 to step S109.

A print job is received from the user in accordance with the selection in step S110. If the user selects a change to an unkeyed discharge tray, the unkeyed discharge tray is determined as the discharge destination of the received print job, and the print job is registered in the print queue. If the user selects an option (either of the two upper options) in FIG. 12 to suspend the print job, the print job is stored in the HD 139 and registered in the suspended job queue as shown in FIG. 11B. In the embodiment, the status changes to “waiting for a free discharge tray” in the suspended job queue when the user selects the first option in FIG. 12, and “waiting for a user instruction” when he selects the second option.

After keyed discharge tray 2 is unlocked and user B takes away print results, the user column for keyed discharge tray 2 in the management table is cleared, as represented on the left side of FIGS. 11A and 11B. Since the discharge destination becomes free, the first suspended job (in this case, job in the status “waiting for a free discharge tray” for user F) in the suspended job queue is automatically added to the bottom of the print queue. Tray 2 is set as the discharge destination, and “waiting for printing” is set as the status.

More specifically, when keyed discharge tray 2 is unlocked, the key control unit 153 detects it. When user B takes away print results, the sheet detection unit 155 detects it. If the key control unit 153 detects locking and subsequent unlocking of the keyed discharge tray, this triggers a program (for example, a print job scheduler; not shown) to run. The sheet detection unit 155 detects the presence/absence of a sheet. If the sheet detection unit 155 detects that no sheet exists, the user column corresponding to the keyed discharge tray from which sheets have been removed is cleared.

Thereafter, the presence/absence of a free discharge tray is determined. The free discharge tray is a keyed discharge tray for which both the user column and prospective user column in the management table are blank. If a free discharge tray exists, the status of the first print job in the suspended job queue is tested. If the status is “waiting for a free discharge tray”, the print job is registered in the print queue, and the identifier of the free discharge tray is recorded in the “discharge destination” column. Further, “waiting for execution” is set as the status, and the owner name of the newly scheduled print job (in other words, the value in the user name column of the print job) is recorded in the prospective user column corresponding to the free discharge tray in the management table.

If the status is “waiting for a user instruction”, a message is output to prompt user authentication and instruction. If the user issues a print instruction again in response to the message, the print job is registered in the print queue. This procedure is the same as that when the status is “waiting for a free discharge tray”. Alternatively, processing complying with another instruction is executed as described in step S113 of FIG. 6B.

When the sheet detection unit 155 detects a sheet, the discharge tray is kept used and no processing is done. If there is no free discharge tray, the print job is not scheduled.

If the first suspended job in the suspended job queue is a job in the status “waiting for a user instruction”, whether to execute the suspended job is inquired of the user when a keyed discharge tray for which neither a user nor a prospective user is set appears in the management table.

### Effects of Embodiment

As described above, upon accepting a print job, whether sheets to be discharged by executing the print job can be discharged is determined based on the discharge statuses of a plurality of discharge units after executing preceding print jobs registered in the print queue. If it is determined that no sheet can be discharged, the user is notified of this.

With the print queue and management table, the user can know whether printed materials to be discharged by executing a print job can be discharged, without waiting for the turn to execute the print job. This can prevent a situation in which there is no available sheet discharge destination in the turn to execute a print job, and the print job is suspended.

Referring to FIGS. 6A and 6B, the embodiment has described a case in which a print request and a print job containing actual image data are separated from each other. The user can select a method of not sending a print job when sheets corresponding to the print job cannot be discharged (cancel button in FIG. 12). However, the present invention is not limited to this, and a print job containing actual image data may be received upon receiving a print request in S101 of FIG. 6A. In this case, the digital multi-function peripheral 100 holds the received print job and performs processes in 5105 and subsequent steps for the held print job. The digital multi-function peripheral 100 executes processing in S108, S112, S113, or S114 without accepting a job again in S108, S112, S113, or S114.

The embodiment has described print jobs received from the PCs 10 to 12. However, the present invention is not limited to this and may be applied to a copy job to print the image of a document read by the reader 120 by the printer 140 in accordance with an instruction from the operation unit 170. In this case, image data read by the reader 120 and print settings accepted via the operation unit 170 are registered as a copy job in the print queue. The above-described processing is done for the registered copy job, obtaining the same effects as those for a print job.

### Modification of Embodiment

In the above-described embodiment, when a print job using a keyed discharge tray (to be simply referred to as a print job) is newly accepted and a preceding print job for a common owner has been scheduled, the newly accepted print job is scheduled with a common discharge tray designated. In the embodiment, however, this rule is not applied to a print job once registered in the suspended job queue.

To solve this, the rule is expanded. When a print job is moved from the suspended job queue to the print queue and a print job identical in owner to the moved print job exists in the suspended job queue, this print job is also moved to the print queue. For this purpose, when a print job extracted from the suspended job queue is newly input in the print queue, user names (owner names) in the suspended job queue are searched for a print job identical in owner to the print job newly input to the print queue. If a print job identical in owner is detected, the status of the detected print job is tested. If the status is “waiting for a free discharge tray”, the detected print job is extracted from the suspended job queue and input to the print queue. The same discharge tray identifier as that of the preceding print job identical in owner is recorded in the “discharge destination” column. Also, the identifier of the print job newly input to the print queue is added to the prospective user column corresponding to the discharge tray in the management table. If the status of the detected print job is “waiting for a user instruction”, the digital multi-function peripheral 100 outputs a message to this effect and waits for an instruction, as described with reference to FIGS. 6A and 6B.

This modification can further increase the use efficiency of a keyed discharge tray.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-117043, filed May 13, 2009, which is hereby incorporated by reference herein in its entirety.

What is claimed is:

1. An image forming apparatus which discharges a sheet bearing an image to one of a plurality of lockable discharge units, the apparatus comprising:
an accepting unit, configured to accept a print job;
a control unit, configured to control to register a print job accepted by said accepting unit in a print queue, and discharge, to one of the plurality of discharge units, a sheet on which an image is formed by executing the registered print job;
a determination unit, configured to, when said accepting unit accepts the print job, determine, based on discharge statuses of the plurality of discharge units after executing a preceding print job registered in the print queue, whether a sheet to be discharged by executing the print job can be discharged; and
a notification unit, configured to, when said determination unit determines that the sheet cannot be discharged, notify a user that the sheet cannot be discharged.

2. The apparatus according to claim 1, wherein when the print job is accepted, a discharge unit to which no sheet is discharged exists, and the preceding print job registered in the print queue is executed to discharge a sheet to the discharge unit to which no sheet is discharged, said determination unit determines that a sheet to be discharged by executing the print job accepted by said accepting unit cannot be discharged.

3. The apparatus according to claim 1, wherein when a discharge unit to which no sheet is discharged even upon executing a preceding print job registered in the print queue exists, said determination unit determines that a sheet to be discharged by executing the print job accepted by said accepting unit can be discharged.

4. The apparatus according to claim 1, further comprising a management unit, configured to manage , as a discharge status of the sheet, a user for each of the plurality of discharge units,
wherein when said control unit executes a print job accepted by said accepting unit to discharge a sheet on which an image is formed, said management unit stores user information corresponding to the print job as a user of the discharge unit in association with the discharge unit.

5. The apparatus according to claim 4, wherein when said accepting unit accepts a print job, and information on the same user as a user corresponding to the print job is stored as a user of one of the plurality of discharge units in association with the discharge unit, said determination unit determines that a sheet to be discharged by executing the print job can be discharged.

6. The apparatus according to claim 1, further comprising an unlocked discharge unit in addition to the plurality of lockable discharge units; and
an instruction unit, configured to, when said accepting unit accepts the print job and said determination unit determines that a sheet to be discharged by executing the print job cannot be discharged, instructing the print job to discharge a sheet to said unlocked discharge unit.

7. The apparatus according to claim 4, further comprising a holding unit, configured to, when said accepting unit accepts the print job and said determination unit determines that a sheet to be discharged by executing the print job cannot be discharged, holding the print job in accordance with a user instruction until discharge to the lockable discharge unit becomes possible.

8. A method performed by an image forming apparatus which discharges a sheet bearing an image to one of a plurality of lockable discharge units, the method comprising the steps of:
accepting a print job;
controlling to register a print job accepted in the accepting step in a print queue, and discharge, to one of the plurality of discharge units, a sheet on which an image is formed by executing the registered print job;
when the print job is accepted in the accepting step, determining, based on discharge statuses of the plurality of discharge units after executing a preceding print job registered in the print queue, whether a sheet to be discharged by executing the print job can be discharged; and
when the sheet is determined in the determination step not to be able to be discharged, notifying a user that the sheet cannot be discharged.

9. A computer-readable medium in which a program for causing a computer to execute a method defined in claim 8 is stored.

10. An image forming apparatus which discharges a sheet bearing an image to one of a plurality of lockable discharge units, the apparatus comprising:
an accepting unit, configured to accept a new print job;
a memory which stores a management table that records use states of the respective lockable discharge units;
a scheduling unit, configured to look up the management table, when all the lockable discharge units are used or reserved by print jobs different in owner from the new print job, notify a user that a free discharge unit which is neither used nor reserved does not exist, and when the free discharge unit exists, input the new print job to the print queue and recording, in the management table, a reservation by the print job as a use state of the free discharge unit; and
an execution unit, configured to extract print jobs sequentially from the print queue, and execute the extracted print jobs using discharge units, reservations of which by the print jobs are recorded in the management table.

11. The apparatus according to claim 10, further comprising a sheet detection unit, configured to detect presence/absence of a discharged sheet for each of the lockable discharge units,
wherein when a user designates execution after standby in response to a notification that no free discharge unit exists, said scheduling unit inputs the new print job in a suspended job queue together with a content of the instruction, and
when said sheet detection unit detects absence of a sheet on the lockable discharge unit, and no reservation is recorded as the use state of the discharge unit as a result of looking up the management table, said scheduling unit extracts a first print job from the suspended job queue, if execution after standby is designated for the print job, inputs the print job to the print queue, and records, in the management table, a reservation by the print job as the use state of a free discharge unit.

12. The apparatus according to claim 11, wherein
when the user designates waiting for an instruction after standby in response to the notification that no free discharge unit exists, said scheduling unit inputs the new print job to the suspended job queue together with a content of the instruction, and
when said sheet detection unit detects absence of a sheet on the lockable discharge unit, and a reservation is recorded as the use state of the discharge unit as a result of looking up the management table, said scheduling unit extracts a first print job from the suspended job queue, and if waiting for an instruction after standby is designated for the print job, sends an inquiry again about the print job to the user.

13. The apparatus according to claim 10, further comprising an unkeyed discharge unit,
wherein when the user designates a change of the discharge unit in response to the notification that no free discharge unit exists, said scheduling unit inputs the print job to the print queue and designates said unkeyed discharge unit as a discharge unit used for the print queue.

14. The apparatus according to claims 10, wherein when a lockable discharge unit used or reserved by a print job identical in owner to the new print job is detected, said scheduling unit inputs the new print job to the print queue and records, in the management table, a reservation by the new print job as a use state of the detected discharge unit.

15. The apparatus according to claim 10, wherein said scheduling unit extracts a first print job from the suspended job queue, inputs the first print job to the print queue, records, in the management table, a reservation of a free discharge unit as a discharge unit used by the print job, searches the suspended job queue for a print job identical in owner to the first print job, and when a print job identical in owner is detected, extracts the print job from the suspended job queue, inputs the print job to the print queue, and further records, in the management table, a reservation by the print job input to the print queue as a use state of the discharge unit reserved by the first print job.
